(19) United States
(12) Patent Application Publication
(10) Pub. No.: US 2025/0164319 A1
(43) Pub. Date: May 22, 2025

(54) THIN CAVITY RESONATOR BY USING LASER FOIL PRINTING

(71) Applicants: Jonghyun Park, Rolla, MO (US); Chulsoon Hwang, Rolla, MO (US); Ming C. Leu, Rolla, MO (US)

(72) Inventors: Jonghyun Park, Rolla, MO (US); Chulsoon Hwang, Rolla, MO (US); Ming C. Leu, Rolla, MO (US)

(73) Assignee: The Curators of the University of Missouri, Columbia, MO (US)

(21) Appl. No.: 18/953,652

(22) Filed: Nov. 20, 2024

Related U.S. Application Data
(60) Provisional application No. 63/601,251, filed on Nov. 21, 2023.

(51) Int. Cl. G01K 5/72; G01K 5/66; G01L 1/25; H01P 7/10; H01P 11/00

(52) U.S. Cl. CPC G01K 5/72; G01K 5/66; G01L 1/25; H01P 7/10; H01P 11/008

(57) ABSTRACT

A structural health monitoring sensor includes a first layer of micromachined planar foil welded to a target structure, the first layer having a cavity and groove formed therein, the groove extending from the first cavity to the exterior of the target structure. The sensor also having second layer of micromachined planar foil welded to the first layer, the second layer having a second cavity corresponding to the first cavity. The sensor also includes dielectric ceramic coating formed within the cavities and grooves to form a film resonator and film waveguide within the target structure. The resulting waveguide forming an opening on the exterior surface of the target structure. The sensor also includes an adapter attached to the exterior surface of the target structure at the waveguide opening and may be wireless.

### CROSS-REFERENCE TO RELATED APPLICATION

This application claims the benefit of U.S. Provisional Patent Application No. 63/601,251, filed Nov. 21, 2023, the entire disclosure of which is incorporated herein by reference.

### BACKGROUND

Structural Health Monitoring (SHM) provides crucial assessment of load-bearing components, detection of damage, and prediction of potential failures. Conventional methods of SHM face challenges such as fragile methods, sensor placement limitations, and risk of failure. Further, many conventional methods of SHM rely on external sensors or wires to transmit a signal. Some methods of additive manufacturing seek to address some of these issues by embedding sensors. However, conventional methods of additive manufacturing that implement embedded sensors often result in parasitic effects on the load-bearing capacity of the structure. Additionally, conventional methods of embedding a wireless sensor face other issues such as power supply, signal range, integration complexity, transmission delays, cost, and sensor lifespan.

Because many methods of additive manufacturing result in structural deficiencies, current methods may fail to create a structurally sound embedded sensor. For example, laser powder bed fusion, which uses lasers to melt powders on a fusion bed to generate a structure, exhibit a relatively lower tensile strength.

### SUMMARY

Aspects of the present disclosure provide a structural health monitoring sensor manufactured within an additive manufacturing process such as laser foil printing (LFP) to wholly integrate the sensor within a structure while limiting impact to structural integrity. LFP uses metallic foils as feedstock in a 3D printing process, offering advantages such as efficient heat conduction, prevention of volume reduction due to porosity, reduced material waste, energy efficiency, and avoidance of potential health hazards associated with powder particles, which are the feedstock of conventional powder-based additive manufacturing such as laser powder bed fusion. Because of the ability to micromachine within the LFP process, an embedded sensor may be constructed with reduced size compared to other additive manufacturing processes.

In an aspect, a structural health monitoring sensor comprises a first layer of micromachined planar foil welded to a target structure, and a second layer of micromachined planar foil welded to the first layer. The first layer of micromachined planar foil has a first cavity and a groove formed therein. The groove extends from the first cavity to an exterior surface of the target structure. The second layer of micromachined planar foil has a second cavity formed therein corresponding to the first cavity of the first layer. The sensor further comprises a dielectric ceramic coating formed within the first and second cavities to create a cavity film and formed within the groove to create a groove film. The first and second cavities and the cavity film define a film resonator and the groove and the groove film define a film waveguide having a waveguide opening at the exterior surface of the target structure.

In another aspect, a method of making a structural health monitoring sensor comprises forming a first cavity and a groove in a first layer of micromachined planar foil. The groove extends from the first cavity to the exterior of a target structure. The method further comprises welding the first layer to a first portion of the target structure wherein the groove and the cavity are oriented to a sensor location. The target structure has the first layer welded thereon forming a first composite structure and filling the groove and the first cavity with a dielectric ceramic material forms a film waveguide within the groove. The method further comprises forming a second cavity corresponding to the first cavity of the first layer in a second layer of micromachined planar foil, aligning the second cavity to the first cavity, and welding the second layer to the first composite structure. The target structure has the first and second layers welded thereon forming a second composite structure. The method further includes removing an excess of the first layer and the second layer from the second composite structure and filling the second cavity with the dielectric ceramic material forming a film resonator within the first and the second cavities. The method also comprises welding a second portion of the target structure to the second composite structure, which forms a complete structure and a waveguide opening at an exterior surface of the complete structure.

In yet another aspect, a method of conducting structural health monitoring in a target structure includes exciting a film resonator embedded in the target structure. The film resonator includes a cavity formed within the target structure and a cavity film, wherein the cavity filmed is formed by a dielectric ceramic coating within the cavity. The method also includes transmitting a resonant frequency through a film waveguide. The waveguide includes a groove formed within the target structure wherein the groove connects the resonator with an area outside the target structure creating a waveguide opening and a groove film, wherein the groove film is formed by the dielectric ceramic coating within the groove. The method further includes receiving, by an adapter, the resonant frequency wherein the adapter is coupled to the waveguide opening and sending, by the adapter, the resonant frequency to a vector network analyzer.

Other objects and features of the present invention will be in part apparent and in part pointed out herein.

### BRIEF DESCRIPTION OF THE DRAWINGS

FIG. 1A illustrates an embedded sensor within a target structure according to an embodiment.

FIG. 1B illustrates an external view of the target structure having an embedded sensor therein according to an embodiment.

FIG. 1C illustrates a detailed view of the embedded sensor according to an embodiment.

FIGS. 2A-2I illustrate a process of making an embedded structural health monitoring sensor in an advanced manufacturing process according to an embodiment.

FIG. 3 illustrates an example of the laser foil printing (LFP) process for use in the process of FIGS. 2A-2I according to an embodiment.

FIGS. 4A-4D illustrate an example spot pattern welding process within the LFP process of FIG. 3 according to an embodiment.

FIG. 5A shows the result of line scan welding in an LFP process according to an embodiment.

FIG. 5B shows the result of spot pattern welding in a LFP process according to an embodiment.

FIG. 6 demonstrates an example of strain and temperature measurements generated by an embedded sensor according to an embodiment.

FIG. 7A illustrates a circuit diagram of a waveguide adapter for use with the embedded sensor of FIGS. 5A-5C according to an embodiment.

FIG. 7B shows an example of a physical waveguide adapter for use with the embedded sensor of FIGS. 5A-5C according to an embodiment.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

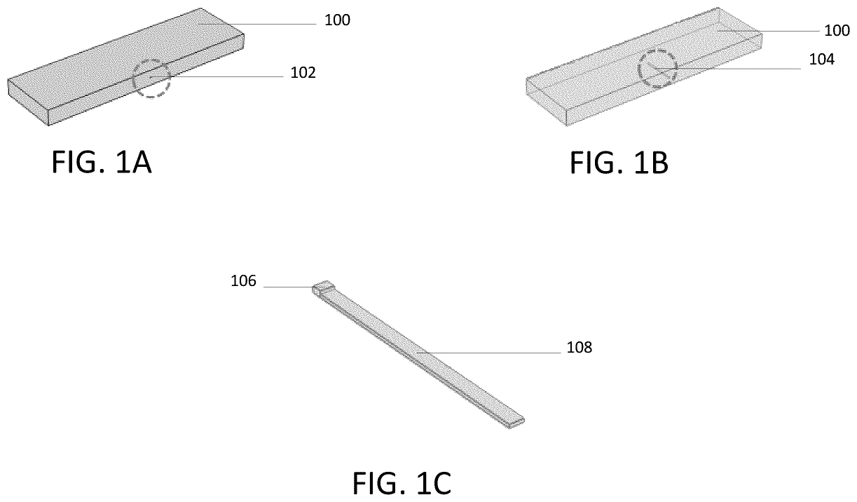

Referring to FIG. 1A, an example resulting monitored manufactured structure 100 only presents a small waveguide opening 102 on the surface of the structure. FIG. 1B shows the resulting internal view of the manufactured structure 100. In some embodiments, an adapter, described further below, attached on the exterior of the structure enables transmission of the resonant frequency. FIG. 1B shows an internal view of the structure with an embedded sensor 104. The sensor 104 extends into the structure to provide optimal monitoring of the structure.

FIG. 1C illustrates a detailed view of the structural health monitoring sensor 104 comprising a resonator 106 coupled to a waveguide 108. The resonator 106 stores electromagnetic energy and oscillates at specific frequencies, which enables measurement of resonant frequencies within the structure. As described below, the resonator 106 and the waveguide 108 each contain a film made from a dielectric ceramic material. The film ensures that both the waveguide 108 and resonator 106 are suitable for detecting strain and temperature while used in harsh environments. Further, the film alters the resonant frequency and other characteristics of the resonator 106.

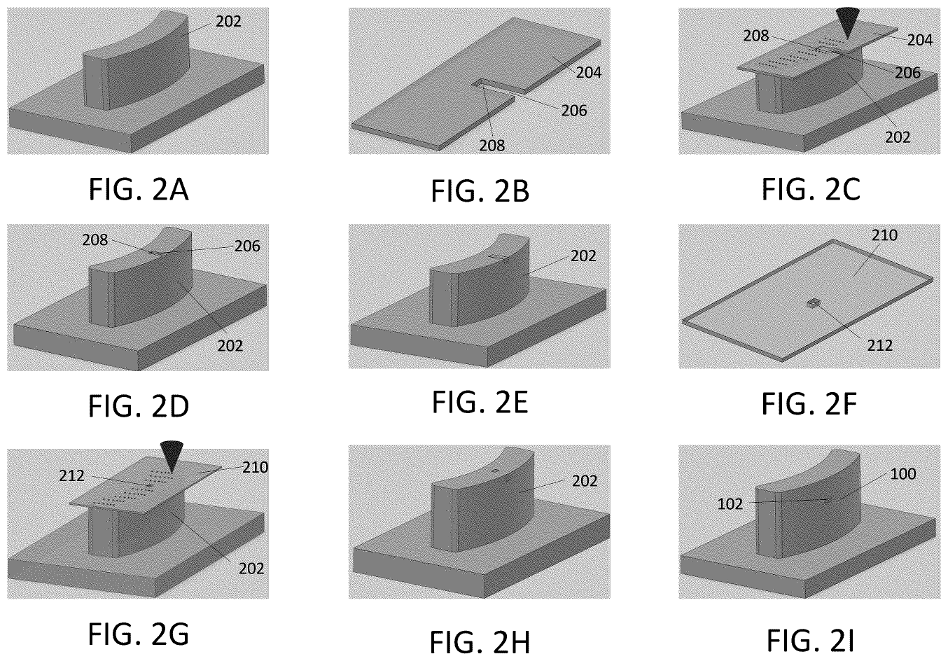

FIGS. 2A through 2I, illustrate one embodiment of a creating sensor 104 within a target manufactured structure 202. As shown in FIG. 2A, a portion of the target structure 202 is constructed up to the desired sensor height. In one embodiment, the target structure 202 is constructed through a laser foil printing process (LFP), described further below. In other embodiments, other forms of additive manufacturing may be used. By constructing the sensor 106 within an additive manufacturing process such as LFP, the sensor 106 becomes wholly integrated and embedded within the structure.

FIG. 2B, shows the construction of a first micromachined metallic planar foil 204 providing a first layer for the resonator 106 and/or waveguide 108. In some embodiments, a laser micromachines the planar foil 204 and cuts the foil 204 to create a groove 206 for a waveguide 108 and/or a first cavity 208 for a resonator 106. In one or more embodiments, the first cavity 208 coextends with a portion of the groove 206 rather than the laser making a separate cut. In other words, the cavity208 comprises an end margin of the groove 206. The first cavity 208 and/or groove 206 vary in size depending on the desired resonant frequencies of the resonator 106 and properties of the target structure 202. In some embodiments, by micromachining the first planar layer 204, construction of the waveguide 108 and resonator 106 occurs on a smaller scale than other method of additive manufacturing and limits the size of the sensor 104, thus limiting the impact on the structure's strength.

FIG. 2C illustrates welding the first micromachined metallic planar foil 204 to the target structure 202. The first planar foil 204 is oriented such that the first cavity 208 aligns with the sensor 104 location and the groove 206 aligns with the waveguide 108 opening. In the present embodiment, the planar foil 204 is welded directly to the target structure 202. In some embodiments, the planar foil 204 is welded through a spot pattern welding technique, described further below. However, in other embodiments a line scanning technique or other methods for welding may be used. After welding the first planar foil 204 to the target structure 202, any excess material is cut from the target structure 202 as demonstrated in FIG. 2D. By removing excess material, the sensor 104 is wholly embedded within the structure with no protrusions from the final structure 100.

FIG. 2E demonstrates filling the groove 206 and cavity 208 with a dielectric ceramic material. In the present embodiment, both the groove 206 and the first cavity 208 are filled with the same dielectric ceramic material. In some embodiments, the filling of the groove and the first cavity 208 occur before removing any excess material as shown in FIG. 2D. The dielectric material facilitates the transmission of the signal from the resonator 106 as well as increases the structural integrity of the target structure over other methods of internal monitoring. Selection of a dielectric impacts performance of the sensor, therefore, a dielectric should be selected based on the sensor's form and function. For example, Al₂O₃ excels at providing thermal stability, low loss, and mechanical robustness. Alternatively, BaTiO₃ provides a high dielectric constant, tenability, and ferromagnetic properties suitable for various applications. Depending on the needs of the sensor either Al₂O₃ or BaTiO₃ may be suitable as a ceramic dielectric material. In other embodiments, the film of the resonator 106 and waveguide 108 are constructed from another dielectric material.

In one embodiment, the groove 206 and first cavity 208 are coated with the dielectric material through a sol-gel process. A sol-gel process enables the coating to be formed in more intricate structural geometries. Sol preparation involves the mixing of a precursor, a catalyzer, and solvents in process parameters such as concentration, molar ratios, viscosity, rotation speed, mixing time, and other environmental factors such as temperature and humidity. The sol forms a three-dimensional network through gelation. Further, the substrate undergoes further coating based on duration time, sample speed, and substrate movement until a desirable surface layer has been achieved. In some embodiments, a low-temperature thermal treatment using a fiber laser facilitates growth of the dielectric ceramic material. Use of a sol-gel process and appropriate dielectric ensures a structurally sound sensor with a robust lifespan to support monitoring within the structure.

Referring now to FIG. 2F, a second micromachined metallic planar foil 210 is constructed providing a second layer for the cavity 212. A laser cuts the second planar foil 210 only to create the second cavity 212. Thus, the laser will cut the second cavity 212 to be aligned with the first cavity 208 which, in some embodiments, coextends with the end of the waveguide 108. FIG. 2G, illustrates welding the second micromachined metallic planar foil 210 to the structure 202, as embodied for the first layer in FIG. 2C.

Referring now to FIG. 2G, like the first layer 204, the second layer of micromachined planar foil 210 is trimmed for excess material around the structure. In some embodiments, instead of removing excess material from the first planar foil 204 as shown in FIG. 2D, the excess of both the first planar foil 204 and the second planar foil 210 are removed from the target structure 202 at one time. Next, the cavity 212 of the second layer is filled with dielectric ceramic material as shown in FIG. 2H. This process replicates the process performed for the first layer in FIG. 2E. In some embodiments, filling the cavity 212 occurs before removing the excess of the second planar foil 210. This process will follow the same steps as described for FIG. 2E. Similarly, in some embodiments, the cavity 212 of the second layer is filled using a sol-gel coating process.

As shown in FIG. 2I, after cutting of any excess planar foil, construction of the remainder of the target structure 202 resumes. As described above, in some embodiments, a laser foil printing process constructs the remainder of the structure on top of the second planar foil 210. The resulting structure 100 features an embedded resonator 106 and embedded waveguide 108 while limiting impact to structural integrity. The indication of the embedded sensor 104 can only be seen externally by the waveguide opening 108 on the surface of the structure with no protrusions from either the first 204 or second layers of planar foils 210. See FIG. 2I. By integrating the sensor 104 into the structure, the sensor requires no wires nor a power supply for the sensor 104 itself. Further, by embedding the sensor 104 within the construction in an additive manufacturing process, the sensor minimizes cost.

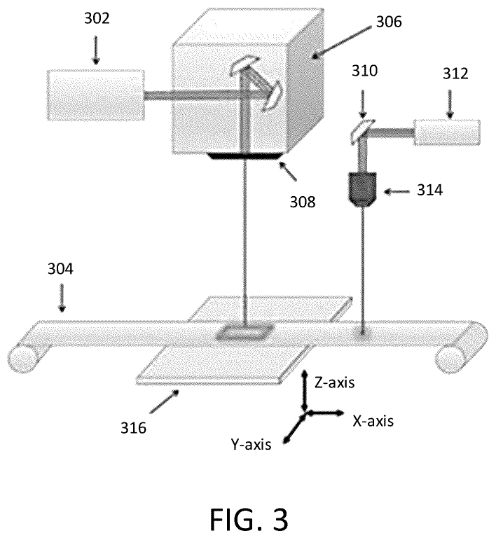

FIG. 3 illustrates aspects of the laser foil printing process. As is known in the art, the laser foil printing (LFP) process is an advanced manufacturing technique where manufacture of a structure occurs by welding a series of metallic foils together. As previously described, LFP provides several advantages over other methods of additive manufacturing such as powder-based methods. LFP offers efficient heat conduction through metallic metal feedstock, prevention of volume reduction caused by porosity in stacked powder, reduction in material waste and energy consumption, and avoidance of health hazards resulting from powder particles. As shown in the example process of FIG. 3, a foil is fed onto a substrate wherein a laser performs any of a series of operations such as line welding, spot welding, or cutting. The laser foil printing process comprises a continuous-wave infrared fiber laser 302, a roller-to-roller foil feeder 304, a galvometer scanning system 306, an F-θ lens 308, a reflector 310, an ultraviolet pulsed laser 312, a focal lens 314, and a 3-axis gantry system 316. The process manufactures a complete structure by placing down subsequent layers of foil on top of the previous foil and welding the layers together.

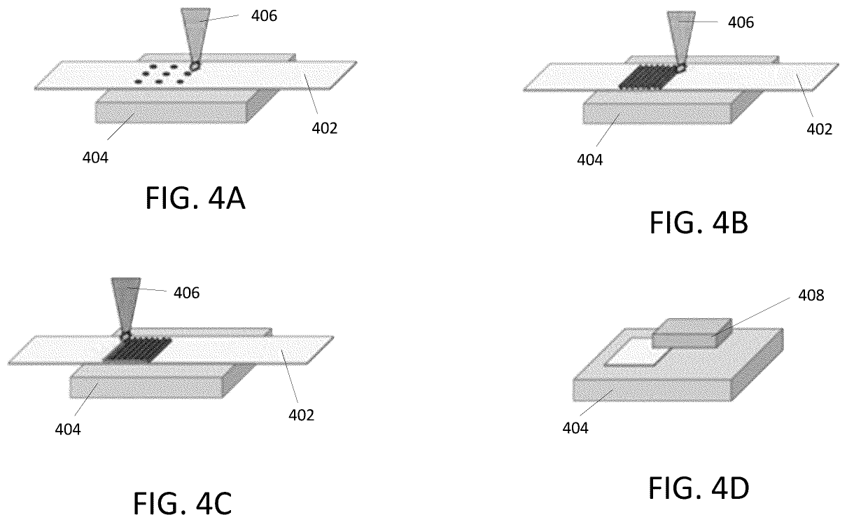

FIGS. 4A through 4D shows an example laser foil printing process using spot pattern welding. As previously described, in some embodiments, the micromachined metallic planar foils are welded to the target structure 202 through spot pattern welding. Spot pattern welding offers a more reliable heating-cooling relationship compared to other methods of welding such as continuous line scanning. Conventional methods of line scan use linear patterns to form the welds in the LFP process. Spot pattern welding relies upon placing dense, uniform weld beads across the welding surface. As shown in FIG. 4A, first a layer of spot welds is set down on the foil 402 on a substrate 404 by a laser beam 406. In FIG. 4B, spot pattern welding continues by setting overlapping weld spots. In FIG. 4C, the laser cuts 406 the structure from the foil 402 before the structure is polished with a grindstone 408 as shown in FIG. 4D.

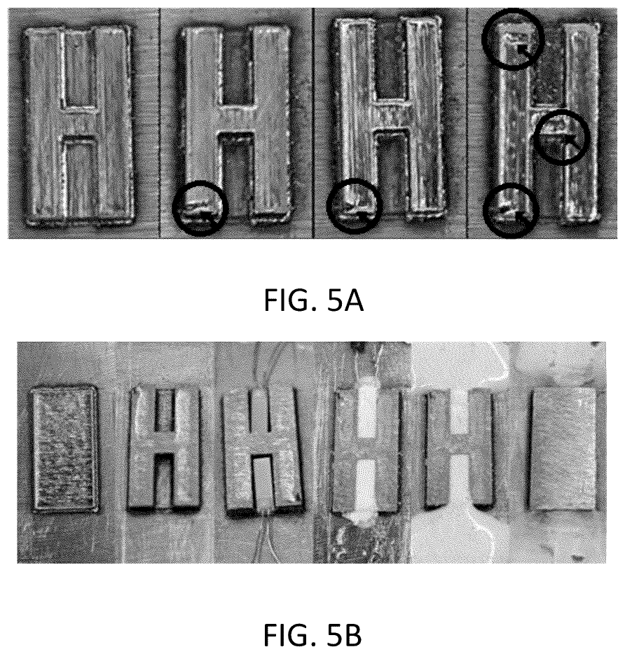

Spot pattern welding provides several benefits of other methods of welding in the LFP process. Spot pattern welding results in more evenly distributed heat due to the overlapping weld spots. As a result, spot pattern welding results in lower risk of defects such caused by thermal cracking, porosity, keyholing, and Marangoni effects. FIG. 5A shows construction of an embedded sensor using a line scan technique. As can be seen most clearly in the second, third, and fourth sensors, this technique can result in structural defects which impact the structure's integrity. In contrast, FIG. 5B shows construction of embedded sensors using the spot pattern welding technique. As can be seen, the sensors are generally free from defects, ensuring a more stable structure and enabling more accurate measurement for the sensor within the structure.

Properties of the resonator 106 enable measurement of temperature and strain within the target structure. The fundamental resonant mode TEₗₘₙ for a dielectric cavity (LₓxL_{y}xL_{z}), such as resonator 106, with a dielectric constant εᵣ(T) and thermal expansion coefficient α under a temperature change ΔT can be found as follows:

$${TE}_{lmn} = \frac{c}{2 \sqrt{{ε}_{r} ( T )}} \sqrt{{( \frac{l}{{L}_{x} ( 1 + {ε}_{x} ) ( 1 + αΔ T )} )}^{2} + {( \frac{m}{{L}_{y} ( 1 + {ε}_{y} ) ( 1 + αΔ T )} )}^{2} + {( \frac{n}{{L}_{z} ( 1 + {ε}_{xz} ) ( 1 + αΔ T )} )}^{2}}$$

where the integers l, m, n represent the mode in the x, y, z directions, respectively, and εₓ, ε_{y}, ε_{z} are the strains in the x, y, z direction, respectively and c is the speed of light. By considering multiple modes, such as (1,1,0), (1,0,1), (1,1,1), and (2,1,0) and pre-measuring the temperature-dependent εᵣ(T) and thermal expansion coefficient α, the strain field and temperature can be decoupled through the equation above.

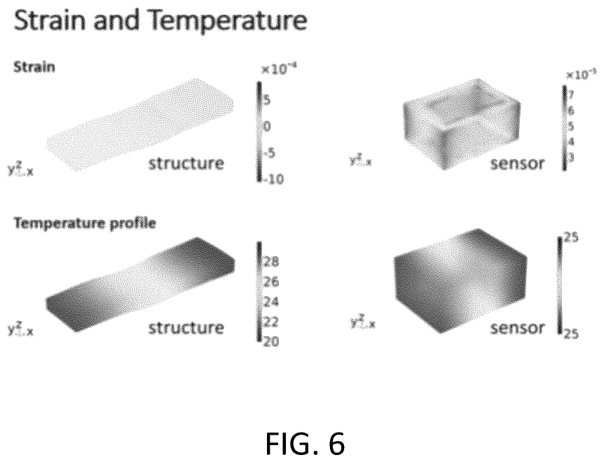

By leveraging the properties of the fundamental resonant mode, the resonator 106 measures strain and temperature independently. Because the resonator 106 exhibits temperature dependency, analyzing changes in the two resonant frequencies enables independent strain and temperature measurement. Therefore, in some embodiments, the resonator 106 measures only a strain within the structure. However, in other embodiments, the resonator 106 measures only temperature within the structure. Embedding multiple sensors within a structure provides a robust system where sensors monitor temperature and strain within the structure individually. FIG. 6 shows an example of a captured measurements of strain and temperature within a structure.

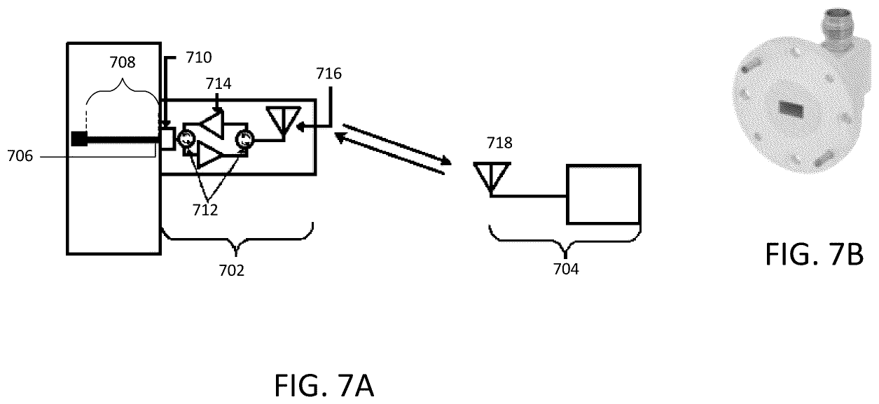

The waveguide 108 extends from the exterior of the target structure to the resonator 106 within the target structure. The waveguide 108 acts as a feeding structure to connect the resonator 106 with the outside of the structure. As previously discussed the waveguide 108 is formed by dielectric material within a groove inside the structure creating a film. The waveguide 108 has no impact on the resonant frequency and as a result, deformation of the waveguide 108 has no impact on signal transmission. Further, the waveguide 108 offers better signal transmission quality than other transmission lines at RF frequencies such as between 3 kilohertz and 300 gigahertz. As described below, the waveguide 108 may be attached to an adapter 702 (see FIG. 7) to transmit the signal to an analyzer outside the structure.

The embedded sensor 104 of the target structure provides several benefits over other methods of structural health monitoring. Embedding the resonator 106 within the target structure 104 eliminates the need for wires within the structure. Further, micromachining the metallic planar foils in constructing the resonator 106 minimizes its size. For example, a resonator 106 can be constructed with dimensions of 0.55 mm×0.45 mm×0.25 mm based upon the size of the planar foil. The minimal size of the resonator 106 enables monitoring of the structure while limiting impact to structural integrity. Similarly, the micromachining process involved in creating the waveguide 108 also limits its impact. Using this process, a waveguide 108 having dimensions such as 0.55 mm×9.5 mm×0.125 mm can be constructed. Further, the dimensions of both the waveguide 108 and resonator 106 may be adjusted to ensure optimal and accurate measurement of resonant frequencies within the sensor 104. Because of the small size of the embedded sensor 104, multiple sensors can be embedded without significantly altering the structural integrity of the structure.

Referring now to FIGS. 7A and 7B, in some embodiments, an adapter 702 mounts to the exterior of the manufactured structure. FIG. 7A shows a circuit view of the adapter 702, while FIG. 7B illustrates one physical embodiment of the adapter 702. The adapter 702 excites the resonator 106 by transmitting signals received from a vector network analyzer (VNA) 704. In the present embodiment, the adapter 702 communicates wirelessly with VNA 704. In other embodiments, the adapter 702 communicates with the VNA 704 through a cable such as a coaxial cable. The adapter 702 attaches to the waveguide opening 706 on the surface of the manufactured structure. The adapter 702 couples with the waveguide 708 with a waveguide-to-coax connector 710.

For accurate measurement from the sensor, the insertion loss of the sensor unit must be measured and the system must be calibrated. Two circulators 712 implement a bi-directional amplification stage through amplifiers 714 to measure the insertion loss. In the present embodiment, an adapter RF antenna 716 coupled to the system transmits signals to and from the VNA 704. In some embodiments, the system comprises only analog circuits without a digital processing unit to reduce complexity of the system. To calibrate channel loss between the adapter RF antenna 716 and the VNA RF antenna 718, the VNA measures the signal with full reflection, which can be achieved by leaving the adapter 702 unmounted during calibration. The system requires calibration to ensure precise correlation of frequency shifts with specific external stimuli.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A structural health monitoring sensor comprising:
a first layer of micromachined planar foil welded to a target structure, the first layer having a first cavity formed therein, the first layer further having a groove formed therein, the groove extending from the first cavity to an exterior surface of the target structure;
a second layer of micromachined planar foil welded to the first layer, the second layer having a second cavity formed therein corresponding to the first cavity of the first layer; and
a dielectric ceramic coating formed within the first and second cavities to create a cavity film and formed within the groove to create a groove film, wherein the first and second cavities and the cavity film define a film resonator and the groove and the groove film define a film waveguide having a waveguide opening at the exterior surface of the target structure.

2. The structural health monitoring sensor of claim 2, wherein the sensor further comprises:
an adapter located at the exterior surface of the target structure and configured for coupling to the film waveguide at the waveguide opening and for transmitting a signal.

3. The structural health monitoring sensor of claim 1, wherein the dielectric ceramic coating comprises a coating selected from the group of Al₂O₃ and BaTiO₃.

4. The structural health monitoring sensor of claim 1, wherein:
the dielectric ceramic coating is formed within the cavity to create the cavity film and within the groove to create the groove film by a sol-gel coating process.

5. A method of making a structural health monitoring sensor, the method comprising:
forming a first cavity and a groove in a first layer of micromachined planar foil, the groove extending from the first cavity to the exterior of a target structure;
welding the first layer to a first portion of the target structure wherein the groove and the cavity are oriented to a sensor location, the target structure having the first layer welded thereon forming a first composite structure;
filling the groove and the first cavity with a dielectric ceramic material to form a film waveguide within the groove;
forming a second cavity corresponding to the first cavity of the first layer in a second layer of micromachined planar foil;
aligning the second cavity to the first cavity and welding the second layer to the first composite structure, the target structure having the first and second layers welded thereon forming a second composite structure;
removing an excess of the first layer and the second layer from the second composite structure;
filling the second cavity with the dielectric ceramic material to form a film resonator within the first and the second cavities; and
welding a second portion of the target structure to the second composite structure, forming a complete structure and a waveguide opening at an exterior surface of the complete structure.

6. The method of claim 5, wherein the method further comprises, after welding the second portion of the structure:
attaching an adapter to the exterior of the target structure at the waveguide opening configured for coupling to the waveguide opening and transmitting a signal.

7. The method of claim 6, further comprising transmitting the signal wirelessly via the adapter.

8. The method of claim 5, wherein the dielectric ceramic material comprises a coating selected from the group of Al₂O₃ and BaTiO₃.

9. The method of claim 5, wherein filling the groove, the first cavity, and the second cavity with a dielectric ceramic material comprises coating the groove and cavity using a sol-gel process.

10. The method of claim 5, wherein the first and the second portions of the target structure are manufactured through a laser foil printing process.

11. The method of claim 5, wherein welding the first layer of micromachined planar foil and welding the second layer of micromachined planar foil further comprise welding, through spot pattern welding.

12. The method of claim 5, wherein the resonator measures temperature.

13. A method of conducting structural health monitoring in a target structure, the method comprising:
exciting a film resonator embedded in the target structure, wherein the resonator comprises:
a cavity formed within the target structure;
a cavity film, wherein the cavity filmed is formed by a dielectric ceramic coating within the cavity;
transmitting a resonant frequency through a film waveguide wherein the film waveguide comprises:
a groove formed within the target structure wherein the groove connects the resonator with an area outside the target structure creating a waveguide opening;
a groove film, wherein the groove film is formed by the dielectric ceramic coating within the groove;
receiving, by an adapter, the resonant frequency wherein the adapter is coupled to the waveguide opening; and
sending, by the adapter, the resonant frequency to a vector network analyzer.

14. The method of claim 13, wherein the adapter comprises a wireless RF adapter.

15. The method of claim 13, where the dielectric ceramic coating comprises a coating selected from the group of Al₂O₃ and BaTiO₃.

16. The method of claim 13, further comprising laser welding one or more micromachined planar metallic foils within the manufactured structure to construct the resonator and the waveguide.

17. The method of claim 16, wherein laser welding the one or more micromachined planar metallic foils comprises spot pattern welding.

18. The method of claim 16, further comprising performing a laser foil printing process to manufacture the target structure.

19. The method of claim 13, wherein the film resonator measures strain of the target structure.

20. The method of claim 13, wherein:
the film waveguide comprises at least a first layer of micromachined planar foil welded to the target structure, the first layer having the groove formed therein; and
the film resonator comprises as least a second layer of micromachined planar foil welded to the first layer, the second layer having the cavity formed therein.
